(19) United States
(12) Patent Application Publication
(10) Pub. No.: US 2024/0253118 A1
(43) Pub. Date: Aug. 1, 2024

(54) MANUFACTURING DEVICE AND MANUFACTURING METHOD FOR SINTERED BODY

(71) Applicant: Samsung Electronics Co., Ltd., Suwon-si (KR)

(72) Inventors: Changhwan Kim, Suwon-si (KR); Takafumi Noguchi, Yokohama-shi (JP); Toshihiro Iizuka, Yokohama-shi (JP); Kenichi Nagayama, Yokohama-shi (JP)

(21) Appl. No.: 18/416,041

(22) Filed: Jan. 18, 2024

(30) Foreign Application Priority Data
Jan. 30, 2023 (JP) 2023-011893
Oct. 6, 2023 (KR) 10-2023-0133391

(51) Int. Cl. B22F 3/14; G01N 29/14

(52) U.S. Cl. CPC B22F 3/14; G01N 29/14; B22F 2302/45; B22F 2999/00; G01N 2291/0231

(57) ABSTRACT

In a manufacturing method for a sintered body, a mold device including a die, first and second punches, first and second spacers, first and second rams, and a plurality of thermal resistors is used. The manufacturing method includes an operation of loading raw material powder into a cavity of the die and then sintering the raw material powder, while pressing and molding the raw material powder in the uniaxial direction using the first and second punches, to form a sintered body and an operation of cooling the formed sintered body. In the operation of cooling the formed sintered body, an acoustic emission (AE) waveform is detected from the formed sintered body, and it is determined whether a crack has occurred in the formed sintered body using the detected AE waveform.

### CROSS-REFERENCE TO RELATED APPLICATION(S)

This application claims benefit of priority to Korean Patent Application No. 10-2023-0133391 filed on Oct. 6, 2023 and Japanese Patent Application No. 2023-011893 filed on Jan. 30, 2023, the disclosures of which are incorporated herein by reference in their entireties.

### BACKGROUND

The present inventive concept relates to a manufacturing device and a manufacturing method for a sintered body.

In a discharge plasma sintering method disclosed in Japanese Patent No. 6475147, a molding material is loaded into a mold for sintering, and discharge plasma sintering is performed on the molding material by applying a voltage, while performing pressing. The mold for sintering includes a cylinder, a first punch inserted into the cylinder from one side of the cylinder, and a second punch inserted into the cylinder from the other side of the cylinder. The first punch and the second punch each have a sliding member between the inner punch and the outer punch.

### SUMMARY

In a discharge plasma sintering method, a mold for sintering formed of isotropic graphite material may be used. In such cases, cracks may occur in a formed sintered body in some cases.

An aspect of the present inventive concept is to provide a manufacturing device and a manufacturing method for a sintered body, capable of suppressing cracking of the sintered body.

According to an aspect of the present inventive concept, a manufacturing device for a sintered body includes: a die, first and second punches, first and second spacers, first and second rams, and a plurality of thermal resistors, wherein the die includes a cavity extending in a uniaxial direction, a first end of each of the first and second punches is disposed inside the cavity of the die, the first ram is disposed at a second, opposite end of the first punch, the first spacer is disposed between the first ram and the first punch, the second ram is disposed at a second, opposite end of the second punch, the second spacer is disposed between the second ram and the second punch, the die, the first and second punches, and the first and second spacers are formed of an isotropic graphite material, and the plurality of thermal resistors are interposed between the first punch and the first spacer, between the first spacer and the first ram, between the second punch and the second spacer, and between the second spacer and the second ram, wherein the plurality of thermal resistors have greater thermal resistance than thermal resistance of the die, the first and second punches, and the first and second spacers.

The manufacturing device may further include: an acoustic emission (AE) wave detecting unit configured to detect an AE waveform from the sintered body, while the sintered body formed in the cavity of the die is cooling; and a crack occurrence determining unit configured to determine whether a crack has occurred in the sintered body using the detected AE waveform.

The crack occurrence determining unit may be configured to determine that a crack has occurred in the formed sintered body when a maximum amplitude value of the detected AE waveform is greater than or equal to a threshold value.

The plurality of thermal resistors may be formed of at least one of graphite paper and carbon fiber-reinforced carbon composite material.

According to an aspect of the present inventive concept, a manufacturing device for a sintered body includes: a mold device including a die, first and second punches, first and second spacers, first and second rams, and a plurality of thermal resistors, wherein the die includes a cavity extending in a uniaxial direction, a first end of each of the first and second punches is disposed inside the cavity of the die, the first ram is disposed at a second, opposite end of the first punch, the first spacer is disposed between the first ram and the first punch, the second ram is disposed at a second, opposite end of the second punch, the second spacer is disposed between the second ram and the second punch, the die, the first and second punches, and the first and second spacers are formed of an isotropic graphite material, the plurality of thermal resistors are interposed between the first punch and the first spacer, between the first spacer and the first ram, between the second punch and the second spacer, and between the second spacer and the second ram, and a computer device configured to control the mold device to load raw material powder into the cavity of the die and then sintering the raw material powder by pressing and molding the raw material powder in the uniaxial direction using the first and second punches to form a sintered body; and cool the formed sintered body, wherein the plurality of thermal resistors have greater thermal resistance than thermal resistance of the die, the first and second punches, and the first and second spacers.

In the operation of cooling the formed sintered body, an acoustic emission (AE) waveform may be detected from the formed sintered body, and whether a crack has occurred in the formed sintered body may be determined using the detected AE waveform.

In the operation of cooling the formed sintered body, when a maximum amplitude value of the detected AE waveform is greater than or equal to a threshold value, it may be determined that the formed sintered body has cracked.

The plurality of thermal resistors may be formed of at least one of graphite paper and carbon fiber-reinforced carbon composite material.

According to an aspect of the present inventive concept, a manufacturing device for a sintered body includes: a die including a cavity extending in a uniaxial direction; a first punch including first and second opposite ends, wherein the first end is disposed in the cavity; a second punch including first and second opposite ends, wherein the first end is disposed in the cavity; a first ram at the second end of the first punch; a first spacer between the first ram and the first punch; a second ram at the second end of the second punch; a second spacer between the second ram and the second punch; a first thermal resistor between the first punch and the first spacer; a second thermal resistor between the second punch and the second spacer; a third thermal resistor between the first spacer and the first ram; and a fourth thermal resistor between the second spacer and the second ram, wherein the first, second, third, and fourth thermal resistors each have greater thermal resistance than that of each of the die, the first and second punches, and the first and second spacers.

### BRIEF DESCRIPTION OF DRAWINGS

The above and other aspects, features, and advantages of the present inventive concept will be more clearly understood from the following detailed description, taken in conjunction with the accompanying drawings, in which:

FIG. 1 is a flowchart illustrating a manufacturing method for a sintered body according to some embodiments;

FIG. 2 is a schematic diagram illustrating a manufacturing device for a sintered body according to some embodiments;

FIG. 3 is a schematic diagram illustrating a first example of a thermal resistor;

FIG. 4 is a schematic diagram illustrating a second example of a thermal resistor;

FIG. 5 is a schematic diagram illustrating a third example of a thermal resistor;

FIG. 6 is a graph illustrating an example of a temperature and acoustic emission (AE) waveform profile in a process of a manufacturing method for a sintered body in Example 1;

FIG. 7 is a graph illustrating an example of a temperature and AE waveform profile in a process of a manufacturing method for a sintered body in Example 2;

FIG. 8 is a schematic diagram illustrating a mold device used in a manufacturing method for a sintered body according to Comparative Examples 1 and 2;

FIG. 9 is a graph illustrating an example of a temperature and AE waveform profile in a process of a manufacturing method for a sintered body in Comparative Example 1; and

FIG. 10 is a graph illustrating an example of a temperature and AE waveform profile in a process of a manufacturing method for a sintered body in Comparative Example 2.

### DETAILED DESCRIPTION

Hereinafter, example embodiments to which the present inventive concept is applied will be described in detail with reference to the drawings. However, the present inventive concept is not limited to the following embodiments. In addition, for clarity of explanation, the following description and drawings are appropriately simplified.

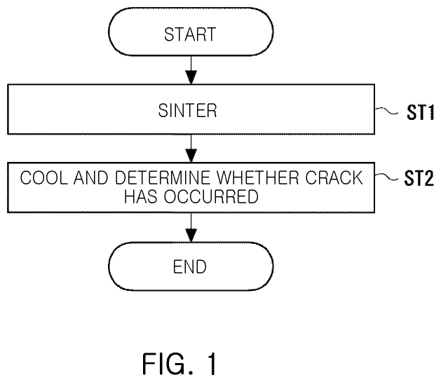

Hereinafter, a manufacturing device for a sintered body according to some embodiments will be described with reference to FIGS. 1 to 5.

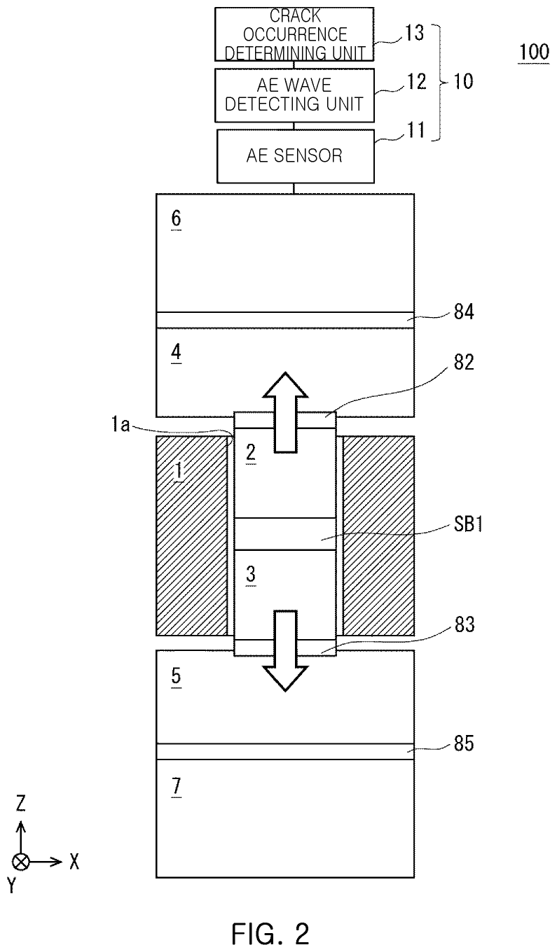

Meanwhile, of course, the right-handed XYZ coordinates illustrated in FIG. 2 and other drawings are for convenience to describe the positional relationships of components. Normally, a Z-axis positive direction is vertically upward direction, and an X-Y plane is a horizontal plane, as is common in drawings.

### <Manufacturing Device for Sintered Body>

First, a manufacturing device for a sintered body according to some embodiments will be described.

As illustrated in FIG. 2, a mold device 100 includes a die 1, a first punch 2, a second punch 3, a first spacer 4, a second spacer 5, a first ram 6, a second ram 7, a plurality of thermal resistors 82, 83, 84, and 85, and an acoustic emission (AE) wave measurement device 10. The mold device 100 is a manufacturing device for a sintered body. In a manufacturing method for a sintered body according to some embodiments, the mold device 100 may be used.

The die 1 has a cavity 1a extending in a uniaxial direction (here, a Z-axis direction). The cavity 1a opens at both opposite ends of the die 1 in the uniaxial direction. The cavity 1a is not particularly limited and may have various shapes depending on a shape of a sintered body to be manufactured. This shape may be a cylindrical shape having, for example, a columnar body, an elliptical cross-section, or a polygonal cross-section.

One end (e.g., a first end) of the first punch 2 and one end (e.g., a first end) of the second punch 3 are disposed inside the cavity 1a of the die 1 and face each other. The first punch 2 and the second punch 3 may be movable in the uniaxial direction in the cavity 1a. The first punch 2 and the second punch 3 may have a cross-sectional shape that is the same or approximately the same as that of the cavity 1a.

The first ram 6 is disposed on the other opposite end (e.g., a second end) of the first punch 2 (here, in a positive Z-axis direction). The first spacer 4 is disposed between the first ram 6 and the first punch 2. The first ram 6 pushes the first punch 2 toward the cavity 1a of the die 1 through the first spacer 4. Inside the first ram 6, a flow path through which a cooling medium may pass may be provided. A circulation device may cool the first ram 6 by circulating the cooling medium through the corresponding flow path.

The second ram 7 is disposed on the other opposite end (e.g., a second end) of the second punch 3 (here, in a negative Z-axis direction). The second spacer 5 is disposed between the second ram 7 and the second punch 3. When the second ram 7 approaches the die 1, the second ram 7 pushes the second punch 3 toward the cavity 1a of the die 1 through the second spacer 5. Inside the second ram 7, a flow path through which a cooling medium may pass may be provided. A circulation device may cool the second ram 7 by circulating the cooling medium through the corresponding flow path.

The thermal resistor 82 (e.g., first thermal resistor 82) is interposed between the first punch 2 and the first spacer 4. The thermal resistor 83 (e.g., second thermal resistor 83) is interposed between the second punch 3 and the second spacer 5. The thermal resistor 84 (e.g., third thermal resistor 84) is interposed between the first spacer 4 and the first ram 6. The thermal resistor 85 (e.g., fourth thermal resistor 85) is interposed between the second spacer 5 and the second ram 7. That is, the first punch 2, the thermal resistor 82, the first spacer 4, the thermal resistor 84, and the first ram 6 are provided in this order from the inside of the cavity 1a of the die 1 to the outside of the cavity 1a beyond the other end of the first punch 2 (here, in the positive Z-axis direction). In addition, the second punch 3, the thermal resistor 83, the second spacer 5, the thermal resistor 85, and the second ram 7 are provided in this order from the inside of the cavity 1a of the die 1 to the outside of the cavity 1a beyond the other end of the second punch 3 (here, in the negative Z-axis direction).

The die 1, the first punch 2, the second punch 3, the first spacer 4, and the second spacer 5 may be formed of an isotropic graphite material.

The thermal resistors 82, 83, 84, and 85 have high thermal resistance (or low thermal conductivity), as compared with the die 1, the first punch 2, the second punch 3, the first spacer 4, and the second spacer 5. The thermal resistors 82, 83, 84, and 85 may be formed of a material having a greater thermal resistance than that of the isotropic graphite material. This material is, for example, at least one of graphite paper and carbon fiber-reinforced carbon composite material. The corresponding graphite paper may also be called graphite sheet. The corresponding graphite paper is, for example, a flexible sheet including graphite. The thermal resistors 82, 83, 84, and 85 may have high thermal resistance when they are formed of at least one of graphite paper and carbon fiber-reinforced carbon composite material.

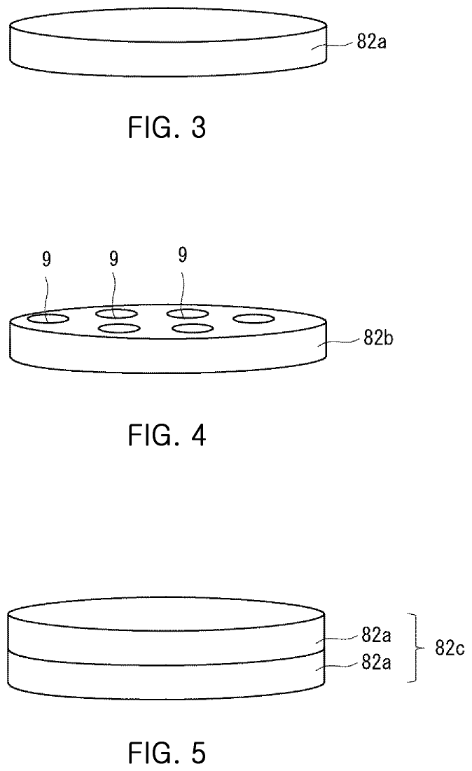

The shape of the thermal resistors 82, 83, 84, and 85 is not particularly limited. For example, as illustrated in FIG. 3, a thermal resistor 82a is an example of the thermal resistors 82, 83, 84, and 85 and is a disk.

As illustrated in FIG. 4, a thermal resistor 82b is an example of the thermal resistors 82, 83, 84, and 85 and is a disk having a plurality of holes 9 (e.g., extending through a body of the thermal resistor 82b). The plurality of holes 9 may collect air, thereby increasing thermal resistance of the thermal resistor 82b. Therefore, the thermal resistance of the thermal resistor 82b may be greater than that of the thermal resistor 82a illustrated in FIG. 3. In addition, the thermal resistors 82, 83, 84, and 85 may include a plurality of solid structures. For example, as illustrated in FIG. 5, a thermal resistor 82c is an example of the thermal resistors 82, 83, 84, and 85 and is formed of two stacked thermal resistors 82a.

The AE wave measurement device 10 illustrated in FIG. 2 includes an AE sensor 11, an AE wave detecting unit or system 12, and a crack occurrence determining unit or system 13. The AE sensor 11 may be connected to a component for pressing the mold device 100 in the uniaxial direction, for example, the die 1, the first punch 2, the second punch 3, the first spacer 4, the second spacer 5, the first ram 6, and the second ram 7. An example of the AE sensor 11 illustrated in FIG. 2 is connected to the first ram 6. The AE sensor 11 detects an AE wave and generates a signal representing the AE wave. The AE wave detecting unit 12 detects an evaluable AE waveform by appropriately amplifying or filtering the generated signal. The crack occurrence determining unit 13 determines whether a crack has occurred in the sintered body using the detected AE waveform. When the maximum amplitude value of the detected AE waveform is equal to or greater than a threshold value, the crack occurrence determining unit 13 determines that a crack has occurred in the sintered body. The AE wave measurement device 10 may include a notification unit for notifying a user of a determination result from the crack occurrence determining unit 13. As a result, the user receives notification of the determination result from the crack occurrence determining unit 13 immediately after the crack occurrence determining unit 13 makes the determination, so that the user may be informed of the occurrence of cracks in the sintered body at an early stage. The AE wave detecting unit 12 and the crack occurrence determining unit 13 may be configured by or included in a computer device.

In an embodiment, the computer device further control the mold device to manufacture the sintered body.

### <Manufacturing Method for Sintered Body>

Next, a manufacturing method for a sintered body according to some embodiments will be described. In the manufacturing method, the mold device 100 is used.

First, raw material powder is sintered, while being pressed and molded in the uniaxial direction, using the first punch 2 and the second punch 3, to form a sintered body SB1 (operation ST1). Specifically, the first punch 2, the thermal resistors 82 and 84, the first spacer 4, and the first ram 6 are spaced apart from the die 1. The raw material powder is loaded into the cavity 1a of the die 1. The second punch 3 is inside the cavity 1a to support the raw material powder. The first punch 2 moves toward the second punch 3, the first punch 2 and the second punch 3 sandwich the raw material powder, and press-mold the raw material powder in the uniaxial direction. Sintering is carried out, while performing the press-molding.

The raw material powder is formed of a material capable of forming a sintered body, and this material is not particularly limited and is, for example, ceramic, such as oxide, carbide, nitride, boride, and fluoride, metal, alloy, or cermet. A specific example of the raw material powder is Y₅O₄F₇ powder, YF₃ powder, or a mixture thereof, and a particle size thereof may be selected from a wide range, for example, 0.3 μm to 0.5 μm. A weight ratio of the mixed powder of Y₅O₄F₇ powder, YF₃ is set to a predetermined value. Y₅O₄F₇ powder is a type of yttrium acid fluoride powder. Details of Y₅O₄F₇ and yttrium oxyfluoride powder will be described below. Meanwhile, the “particle size” of the raw material powder is the “median diameter (D50)” of the primary particle size measured using a particle size distribution measurement device, for example, MT3300 manufactured by MICROTRAC, based on a laser diffraction/scattering method.

The sintering method is not particularly limited, but may be, for example, a spark plasma sintering (SPS) method or a hot press (HP) method.

The SPS method is an abbreviation for discharge or spark plasma sintering. A workpiece is sintered by mechanical pressurization and pulsed electric current heating. It is generally known that sintering by the SPS method enables densification at low temperatures or within a short time and increases density by suppressing grain growth. Specifically, the raw material powder is introduced into the mold device 100 as is and sintered under various conditions using an SPS device. Sintering conditions include an atmospheric pressure, a temperature increase rate, a holding temperature, a holding time, a temperature decrease rate, and a holding pressure. For example, when the raw material powder is Y₅O₄F₇ powder, YF₃ powder, or mixed powder thereof, the holding temperature range may be set to 750° C. to 1000° C.

The HP method is an abbreviation for hot press molding method. Raw material powder may also be hot-press molded using the mold device 100. Specifically, first, the raw material powder is loaded into the cavity 1a of the die 1 of the mold device 100 and hot-press molded under various conditions. Hot press conditions include an atmospheric gas, pressure, a temperature increase rate, a holding temperature, a holding time, a temperature decrease rate, and a holding pressure. For example, when the raw material powder is Y₅O₄F₇ powder, YF₃ powder, or mixed powder thereof, the holding temperature may be set to 700° C. to 1000° C. Meanwhile, prior to the hot-press molding method, the raw material powder may be first molded. Specifically, the raw material powder is loaded into the cavity 1a of the die 1 of the mold device 100. Pressure is applied to the raw material powder using a hydraulic press to form a primary molded body. The primary molded body may be separately obtained from the mold, and hot-press molding may be performed using the mold device 100 as described above.

Next, the sintered body SB1 is cooled (operation ST2). Specifically, the sintered body SB1 is cooled until a temperature of the sintered body SB1 reaches room temperature from the aforementioned holding temperature. In addition, for example, the temperature decrease rate of the sintered body SB1 may be adjusted by changing the amount of cooling medium circulated in the flow paths of the first ram 6 and the second ram 7.

In operation ST2, an AE waveform is detected from the sintered body SB1. It is determined whether a crack has occurred in the sintered body SB1 using this detected AE waveform. For example, if the maximum amplitude value of the AE waveform is greater than or equal to the threshold value, it is determined that the sintered body SB1 has cracked, and if the maximum amplitude value of the AE waveform is less than the threshold value, it is determined that the sintered body SB1 has not cracked. The threshold value may be obtained empirically for each manufacturing condition, for example, by conducting an experiment.

From the above, the thermal resistors 82, 83, 84, and 85 are interposed between the first punch 2 and the first spacer 4, between the second punch 3 and the second spacer 5, between the first spacer 4 and the first ram 6, and between the second spacer 5 and the second ram 7, respectively. In addition, the thermal resistors 82, 83, 84, and 85 have higher thermal resistance as compared to the die 1, the first punch 2, the second punch 3, the first spacer 4, and the second spacer 5. Therefore, the thermal resistors 82, 83, 84, and 85 suppress heat dissipation from the sintered body SB1, and the temperature decrease rate of the sintered body SB1 is reduced. Therefore, thermal shock applied to the sintered body SB1 is suppressed, and the occurrence of cracks in the sintered body SB1 is suppressed.

Furthermore, in operation ST2, it is determined whether a crack has occurred in the sintered body SB1 using the AE waveform detected from the sintered body SB1. Therefore, it is possible to detect cracks in the sintered body SB1 at an early stage. As a result, the sintered body SB1 in which cracks have not occurred may be obtained by removing the cracked sintered body or modifying the sintering conditions. As a result, the occurrence of cracks in the sintered body SB1 may be suppressed.

Furthermore, in operation ST2 according to some embodiments, when the maximum amplitude value of the AE waveform is equal to or greater than the threshold value, it is determined that a crack has occurred in the sintered body SB1. Thereby, the accuracy of determining the occurrence of cracks in the sintered body SB1 may increase.

In addition, the thermal resistors 82, 83, 84, and 85 according to some embodiments are formed of at least one of graphite paper and carbon fiber-reinforced carbon composite material and have high thermal resistance. Therefore, thermal shock applied to the sintered body SB1 may be further suppressed, and the occurrence of cracks in the sintered body SB1 may be further suppressed.

In addition, when the raw material powder in operation ST1 is Y₅O₄F₇ powder, the sintered body SB1 includes 50 [mass %] or more of yttrium acid oxide, and thus chemical corrosion is small as compared to a sintered body including Y₂O₃. In addition, in this case, the sintered body SB1 has good plasma resistance because there are few voids when a relative density is a predetermined value or greater. In addition, in this case, the sintered body SB1 has a Vickers hardness of a predetermined value or greater, so it has good plasma resistance and is unlikely to cause scratches on the surface. From the above, when the raw material powder is Y₅O₄F₇ powder, the sintered body SB1 has high corrosion resistance. Therefore, the sintered body SB1 is suitable as a component of a semiconductor manufacturing device or a member for a plasma device. The corresponding member for a plasma device is, for example, an edge ring, a shower nozzle, or a window. The corresponding window is a member transmitting at least radio waves.

In addition, YF₃ has a linear expansion coefficient greater than Y₅O₄F₇. Therefore, YF₃ is more likely to cause cracks in the sintered body compared to Y₅O₄F₇. Even when the raw material powder is YF₃ powder, according to some embodiments, the occurrence of cracks in the sintered body SB1 may be suppressed. Therefore, in the manufacturing device for a sintered body and the manufacturing method for a sintered body according to some embodiments, the raw material powder may preferably be YF₃ powder.

(Y₅O₄F₇ and Yttrium Oxyfluoride Powder)

Hereinafter, yttrium acid fluoride powder will be described. In the present inventive concept, the material indicated as “Y₅O₄F₇” is a material identified as “Y₅O₄F₇” as a result of X-ray diffraction analysis (XRD analysis). Yttrium acid fluoride is known to be a material in which Y, O, and F are combined in various ratios. These materials are similar in elemental composition and crystal structure to Y₅O₄F₇, and sintered bodies using these yttrium acid fluorides also exhibit the same effects as those of Y₅O₄F₇ according to the present inventive concept.

For example, according to a database of powder X-ray diffraction patterns based on the International Center for Diffraction Data (ICDD), compounds having a structure similar to that of Y₅O₄F₇ described in the examples of the present inventive concept include Y₆O₅F₈, Y₇O₆F₉, Y₁₇O₁₄F₂₃, and Y₁O_{0.826}F_{1.348}. X-ray diffraction peaks of these five yttrium oxide fluorides, including Y₅O₄F₇, are very similar in peak positions and peak intensities. In actual X-ray diffraction measurements, it is difficult to completely specify these five substances because the peak intensity changes or the peak position shifts depending on a state of a measured sample or due to a measurement error of a device.

For the above reasons, the material indicated as “Y₅O₄F₇” according to the present inventive concept includes these similar yttrium oxide fluorides.

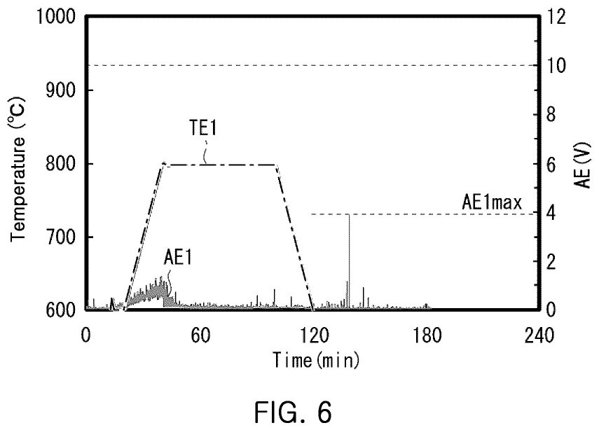

Next, manufacturing of a sintered body using the manufacturing method for a sintered body and the results of evaluation will be described with reference to FIGS. 6 to 10.

### <Manufacturing Conditions for Sintered Body>

In Examples 1 and 2, the sintered body was manufactured using the same manufacturing method as that of the sintered body described above using the mold device 100 of FIG. 2.

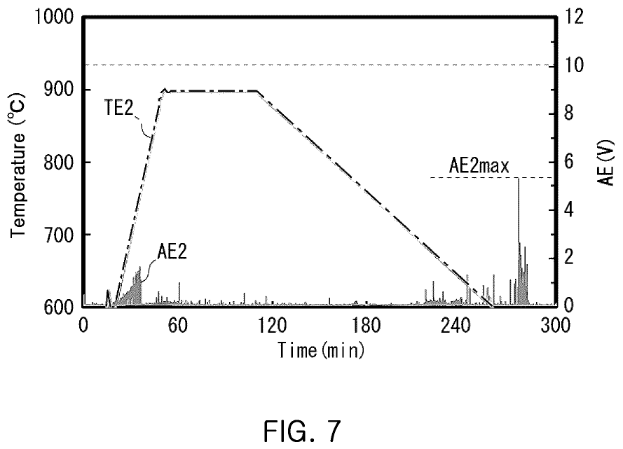

In Example 1, in operation ST1, Y₅O₄F₇ powder having a particle size of 0.3 μm was used as the raw material powder. In addition, the raw material powder, Y₅O₄F₇ powder, was loaded as is into a mold device corresponding to the mold device 100 and sintered under various conditions using an SPS device (SPS-515, a product of Fuji Electric Co., Ltd.). The sintering conditions were vacuum (about 3 Pa) or argon (Ar) gas (flow rate 1 L/min), the temperature increase rate was 10 to 100° C./min, the holding temperature was 800° C., and the holding time was about 1 hour. In operation ST2, the temperature decrease rate was 2 to 50° C./min up to 200° C., and in the case of a temperature lower than 200° C., furnace cooling was performed, and pressure was increased at the same time as a temperature increase to reach the holding pressure for 1 minute. The holding pressure was 40 MPa, and pressure reduction was set to start immediately upon completion of the temperature holding and pressure reduction was set to be terminated at a temperature of 200° C. In operations ST1 and ST2, the temperature of the raw material powder (sintered body SB1) and the AE waveform was continuously detected. A temperature curve TE1 and an AE waveform curve AE1 are illustrated in FIG. 6. For Example 2, the same conditions as those of Example 1 were set, except that the particle size of the raw material powder YF₃ was 0.5 μm and the holding temperature was 900° C. A temperature curve TE2 and an AE waveform curve AE2 are illustrated in FIG. 7.

Meanwhile, in Comparative Example 1, a sintered body was manufactured using the same manufacturing method as that of Example 1, except that a mold device corresponding to the mold device 900 was used.

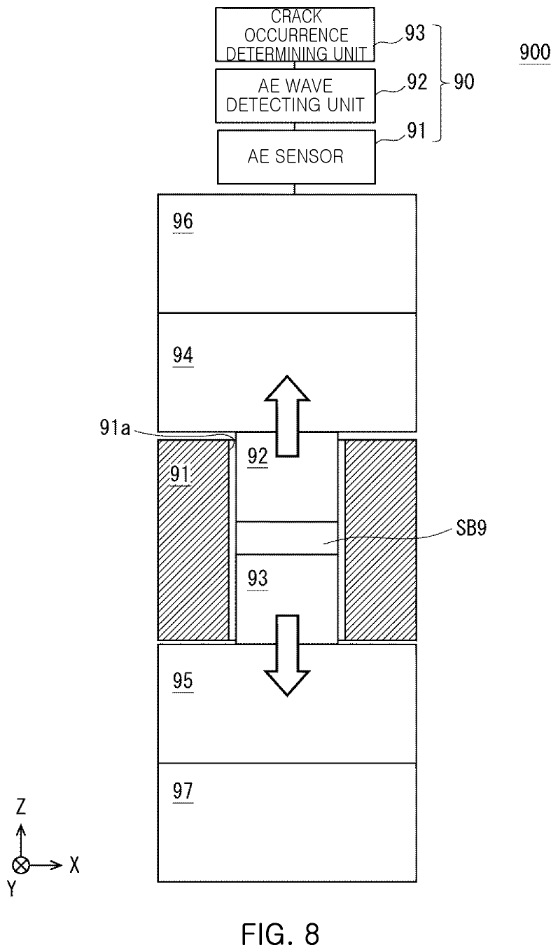

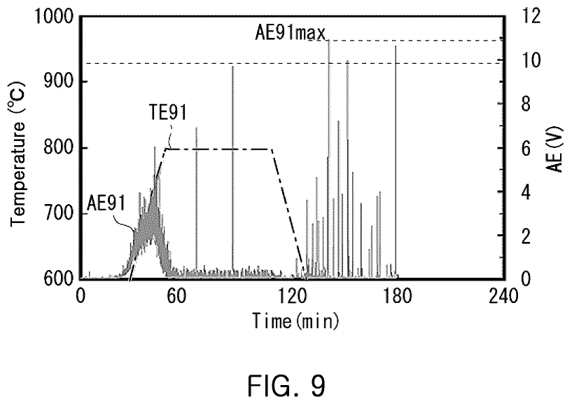

As illustrated in FIG. 8, the mold device 900 has the same configuration as that of the mold device 100, except that the thermal resistors 82, 83, 84, and 85 are not provided. The mold device 900 includes a die 91, a first punch 92, a second punch 93, a first spacer 94, a second spacer 95, a first ram 96, a second ram 97, and an AE wave measurement device 90. The die 91, the first punch 92, the second punch 93, the first spacer 94, the second spacer 95, the first ram 96, the second ram 97, and the AE wave measurement device 90 are configured to be the same as the die 1, the first punch 2, the second punch 3, the first spacer 4, the second spacer 5, the first ram 6, the second ram 7, and the AE wave measurement device 10, respectively. In operations ST1 and ST2, detection of the temperature of the raw material powder (sintered body SB9) and the AE waveform was continued. A temperature curve (TE91) and an AE waveform curve AE91 are illustrated in FIG. 9. In Comparative Example 2, the same conditions as those of Comparative Example 1 were set, except that the raw material powder was YF₃ powder having a particle size of 0.5 μm and the holding temperature was 900° C. A temperature curve TE92 and an AE waveform curve AE92 are illustrated in FIG. 9.

As illustrated in FIG. 6, in Example 1, in operations ST1 and ST2, the maximum amplitude value AE1max of the AE waveform curve AE1 was about 4V and 10V or less. As illustrated in FIG. 7, in Example 2, in operations ST1 and ST2, the maximum amplitude value AE2max of the AE waveform curve AE2 was about 5 V and 10 V or less. It was confirmed that no cracks occurred in any of the sintered bodies according to Examples 1 and 2 after being removed from the mold device. One of the reasons for this is that the mold device used in Examples 1 and 2 included a thermal resistor, so cooling of the sintered bodies according to Examples 1 and 2 in the uniaxial direction was suppressed.

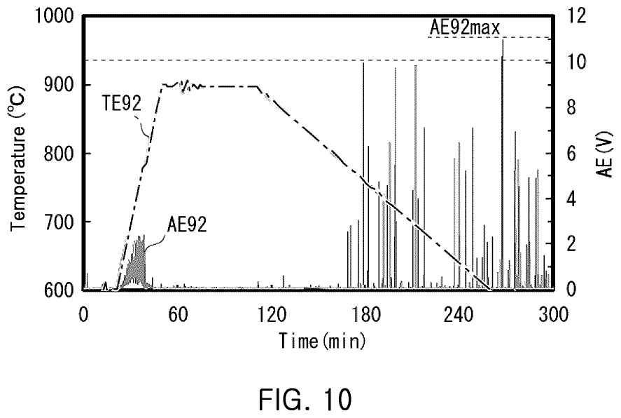

As illustrated in FIG. 9, in Comparative Example 1, in the operations ST1 and ST2, the maximum amplitude value AE91max of the AE waveform curve AE91 was about 11 V, exceeding 10 V. As illustrated in FIG. 10, in Comparative Example 2, in the operations ST1 and ST2, the maximum amplitude value AE92max of the AE waveform curve AE92 was about 11 V, exceeding 10 V. It was confirmed that cracks occurred in both of the sintered bodies according to Comparative Examples 1 and 2 after being removed from the mold device. A reason for this may attribute to a factor that, unlike the mold device used in Examples 1 and 2, the mold device used in Comparative Examples 1 and 2 did not have a thermal resistor, so the sintered bodies according to Comparative Examples 1 and 2 were easily cooled in the uniaxial direction.

According to the present inventive concept, cracking of the sintered body may be suppressed.

While example embodiments have been illustrated and described above, it will be apparent to those skilled in the art that modifications and variations could be made without departing from the scope of the present inventive concept as defined by the appended claims.

What is claimed is:

1. A manufacturing device for a sintered body, the manufacturing device comprising:
a die, first and second punches, first and second spacers, first and second rams, and a plurality of thermal resistors,
wherein the die includes a cavity extending in a uniaxial direction,
a first end of each of the first and second punches is disposed inside the cavity of the die,
the first ram is disposed at a second, opposite end of the first punch,
the first spacer is disposed between the first ram and the first punch,
the second ram is disposed at a second, opposite end of the second punch,
the second spacer is disposed between the second ram and the second punch,
the die, the first and second punches, and the first and second spacers are formed of an isotropic graphite material, and
the plurality of thermal resistors are interposed between the first punch and the first spacer, between the first spacer and the first ram, between the second punch and the second spacer, and between the second spacer and the second ram,
wherein the plurality of thermal resistors have greater thermal resistance than thermal resistance of the die, the first and second punches, and the first and second spacers.

2. The manufacturing device of claim 1, further comprising:
an acoustic emission (AE) wave detecting unit configured to detect an AE waveform from the sintered body, while the sintered body formed in the cavity of the die is cooling; and
a crack occurrence determining unit configured to determine whether a crack has occurred in the sintered body using the detected AE waveform.

3. The manufacturing device of claim 2, wherein the crack occurrence determining unit is configured to determine that a crack has occurred in the formed sintered body when a maximum amplitude value of the detected AE waveform is greater than or equal to a threshold value.

4. The manufacturing device of claim 3, wherein the threshold value is obtained by conducting an experiment.

5. The manufacturing device of claim 1, wherein the plurality of thermal resistors are formed of at least one of graphite paper and carbon fiber-reinforced carbon composite material.

6. The manufacturing device of claim 1, wherein each of the plurality of thermal resistors is a disk.

7. The manufacturing device of claim 1, wherein each of the plurality of thermal resistors is a disk including a plurality of holes.

8. The manufacturing device of claim 1, wherein each of the plurality of thermal resistors include a plurality of solid structures.

9. The manufacturing device of claim 1, wherein each of the plurality of thermal resistors includes two stacked thermal resistors.

10. The manufacturing device of claim 1, wherein the cavity has a cylinder shape.

11. The manufacturing device of claim 1, wherein the cavity has an elliptical or polygonal cross-section.

12. A manufacturing device for a sintered body, the manufacturing device comprising:
a mold device including a die, first and second punches, first and second spacers, first and second rams, and a plurality of thermal resistors,
wherein the die includes a cavity extending in a uniaxial direction,
a first end of each of the first and second punches is disposed inside the cavity of the die,
the first ram is disposed at a second, opposite end of the first punch,
the first spacer is disposed between the first ram and the first punch,
the second ram is disposed at a second, opposite end of the second punch,
the second spacer is disposed between the second ram and the second punch,
the die, the first and second punches, and the first and second spacers are formed of an isotropic graphite material,
the plurality of thermal resistors are interposed between the first punch and the first spacer, between the first spacer and the first ram, between the second punch and the second spacer, and between the second spacer and the second ram, and
a computer device configured to control the mold device to load raw material powder into the cavity of the die and then sintering the raw material powder by pressing and molding the raw material powder in the uniaxial direction using the first and second punches to form a sintered body, and cool the formed sintered body,
wherein the plurality of thermal resistors have greater thermal resistance than thermal resistance of the die, the first and second punches, and the first and second spacers.

13. The manufacturing device of claim 12, wherein the computer device is further configured to: detect an acoustic emission (AE) waveform from the formed sintered body, while cooling the formed sintered body, and determine whether a crack has occurred in the formed sintered body using the detected AE waveform.

14. The manufacturing device of claim 13, wherein the computer device is further configured to determine, when a maximum amplitude value of the detected AE waveform is greater than or equal to a threshold value, determining that the formed sintered body has cracked, while cooling the formed sintered body.

15. The manufacturing device of claim 12, wherein the plurality of thermal resistors are formed of at least one of graphite paper and a carbon fiber-reinforced carbon composite material.

16. The manufacturing device of claim 12, wherein the computer device is further configured to cool the formed sintered body until a temperature of the formed sintered body reaches room temperature.

17. The manufacturing device of claim 12, wherein the raw material powder is Y₅O₄F₇ powder or YF₃ powder.

18. A manufacturing device for a sintered body, the manufacturing device comprising:
a die including a cavity extending in a uniaxial direction;
a first punch comprising first and second opposite ends, wherein the first end is disposed in the cavity;
a second punch comprising first and second opposite ends, wherein the first end is disposed in the cavity;
a first ram at the second end of the first punch;
a first spacer between the first ram and the first punch;
a second ram at the second end of the second punch;
a second spacer between the second ram and the second punch;
a first thermal resistor between the first punch and the first spacer;
a second thermal resistor between the second punch and the second spacer;
a third thermal resistor between the first spacer and the first ram; and
a fourth thermal resistor between the second spacer and the second ram,
wherein the first, second, third, and fourth thermal resistors each have greater thermal resistance than that of each of the die, the first and second punches, and the first and second spacers.

19. The manufacturing device of claim 18, wherein further comprising an acoustic emission (AE) wave measurement device configured to detect an AE waveform from the sintered body, while the sintered body formed in the cavity of the die is cooling, and to determine whether a crack has occurred in the sintered body using the detected AE waveform.

20. The manufacturing device of claim 19, wherein the AE wave measurement device is configured to determine whether a crack is present in the sintered body using the detected AE waveform.
